(19) United States
(12) Patent Application Publication
(10) Pub. No.: US 2007/0037539 A1
(43) Pub. Date: Feb. 15, 2007

(54) Method of suppressing co-channel interference in a wireless communication system

(75) Inventor: Yung-Ting Lee, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/260,438

(22) Filed: Oct. 28, 2005

(30) Foreign Application Priority Data
Aug. 11, 2005 (TW) 094127281

(51) Int. Cl. H04B 1/18; H04B 1/10

(52) U.S. Cl. 455/302; 455/285

(57) ABSTRACT

A method of suppressing co-channel interference in a wireless communication system, which computes the power intensities of coherent signals in different spatial orientations based on a result generated when the preamble of a main signal to be received by a wireless receiver is orthogonal to the preambles of interference signals, which are in co-channel with the main signal, so that the main signal can be separated for further processing. The wireless receiver finds an orientation relative to a wireless transmitter and notices the wireless transmitter the orientation such that the wireless transmitter can enhance a power intensity of the main signal and/or reduce the interference signals sent by interference sources.

### BACKGROUND OF THE INVENTION

1. Field of the Invention

The invention relates to a method of suppressing co-channel interference and, more particularly, to a method of suppressing co-channel interference in a wireless communication system by using preamble and spatial filters.

2. Description of Related Art

Communication systems, such as mobile phones, networks, or other wireless or wired communication apparatus, play a dominant role on modern living. Particularly, the future development has focused on wireless communication systems, such as IEEE 802.16, UVVB, etc. However, the co-channel interference in such wireless communications may affect the receiving quality, and it becomes an important problem to solve.

The co-channel interference means that a receiver at a receiving end will receive both a desired signal transmitted by a transmitter at a transmitting end and the co-channel signals transmitted by all surrounding interference sources. Due to the co-channel of the received signals, a conventional frequency filter implemented in the receiver cannot separate the desired signal from the received signals in demodulation. In this case, if an interference source transmits a very strong signal, the receiver may not recognize any signal sent by the transmitter, which causes a communication problem. In general, the existing communication systems use an STC coding to process signals for transmission, and responsively decode and restore the signals or add an equalizer to process the signals at the respective receiving ends. However, the effect in such a way is relatively reduced when an interference signal is too strong, i.e., the error rate in this case is relatively increased so that the entire communication system cannot work in normal. Therefore, it is desirable to provide an effective method of suppressing co-channel interference in a wireless communication system to mitigate and/or obviate the aforementioned problems.

### SUMMARY OF THE INVENTION

An object of the invention is to provide a method of suppressing co-channel interference in a wireless communication system, which is used in a wireless receiver. The method includes: a co-channel receiving step, a power intensity computing step, a power intensity comparing step, and a filtering step. The co-channel receiving step receives a plurality of signals with the same frequency. The signals contain a main signal and one or more interference signals. The main signal is transmitted by a wireless transmitter with a preamble orthogonal to the preambles of interference signals. The power intensity computing step computes power intensities respectively of the signals based on the preambles. The power intensity comparing step compares the power intensities in weighting. The filtering step selects a signal with power intensity higher than a threshold as the main signal, and spatially filters out the remaining signals that are regarded as the interference signals from different impinging angles.

Another object of the invention is to provide a method of suppressing co-channel interference in a wireless communication system, which is used in a wireless transmitter. The method includes the steps: a main signal transmitting step, a response receiving step, and a signal enhancing step. The main signal transmitting step transmits a main signal with an assigned frequency to a wireless receiver. The main signal contains a preamble. The response receiving step receives a response message sent by the wireless receiver. The response message contains a message of orientation, which is computed by the wireless receiver based on the main signal. The signal enhancing step is based on the message of orientation to obtain the position where the wireless receiver is located, and then enhance the power intensity of the main signal transmitted in an impinging angle to the position, thereby increasing the signal to noise ratio and communication quality.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a system according to an embodiment of the invention;

FIG. 2 is a flowchart of a receiver according to an embodiment of the invention; and

FIG. 3 is a flowchart of a transmitter according to an embodiment of the invention.

### DETAILED DESCRIPTION OF THE PREFERRED EMBODIMENT

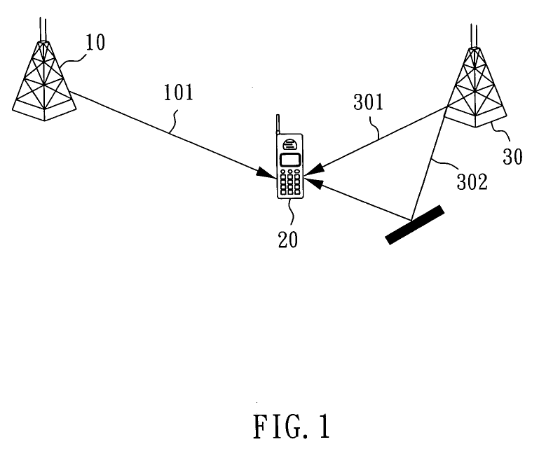

FIG. 1 is a schematic view of a wireless communication system according to an embodiment of the invention, in which each communication device contains a unique preamble orthogonal to one another for physical synchronization between the communication devices. As shown in FIG. 1, a wireless transmitter, i.e., a base station 10, transmits a main signal 101 to a wireless receiver, i.e., a mobile phone 20. In this case, an interference source is another base station 30, which transmits an interference signal 301 in co-channel with the main signal 101. The mobile phone 20 receives the interference signal 301 and a reflected interference signal 302, in addition to the main signal 101. Since the main signal 101 is in co-channel with the interference signals 301, 302, the mobile phone 20 cannot separate the main signal 101 and thus incurs co-channel interference. Accordingly, it is necessary to filter out the interference signals 301, 302 or enhance a power of the main signal 101 for transmission.

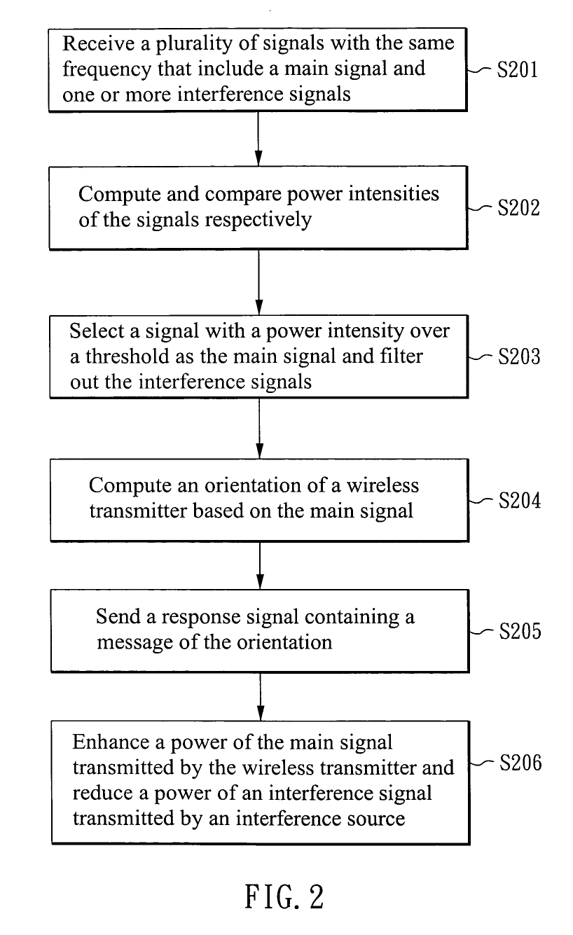

FIG. 2 is a flowchart of a receiver according to an embodiment of the invention. Referring to FIGS. 1 and 2, the mobile phone 20 receives the main signal 101 and the interference signals 301, 302 (S201). Since the signals 101, 301 and 302 have the respective preambles orthogonal to one another, the mobile phone 20 can accordingly compute power intensities respectively of the signals 101, 301 and 302 for comparison (S202). Because the power intensity of the main signal 101 is generally greater than those of the interference signals 301 and 302, the mobile phone 20 can set an adjustable threshold smaller than the power intensity of the main signal 101 and greater than the remaining ones. Thus, the mobile phone 20 further computes a weight of an internal spatial filter such as a smart antenna array (not shown) based on the preamble of the main signal 101 in order to set a larger power gain to the main signal 101 and a smaller power gain to the interference signals 301 and 302, thereby separating the main signal 101 and filtering out the interference signals 301 and 302 (S203). Therefore, the main signal 101 is extracted successfully by the mobile phone 20 for further demodulation, and thus the signal to noise ratio is increased and the error rate is reduced. In addition, multiple path transmission may present in a wireless channel, which can cause co-channel signals to heavily affect the performance of the antenna array. To overcome this, step S203 can further provide a spatial smoothing in computing the weight of the antenna array based on a number of antenna sub-arrays in the antenna array.

Furthermore, the mobile phone 20 can compute an orientation relative to the base station 10 according to the main signal 101 (S204), and sends a response message containing a message of the orientation (S205). The base station 10 receives the response message and accordingly enhances the power intensity of the main signal 101 transmitted in an impinging angle to the mobile phone 20. The interference source (base station 30) also receives the response message and accordingly reduces the power intensities of the interference signals 301 and 302 transmitted in an impinging angle to the mobile phone 20 (S206). As such, the signal to noise ratio of the entire communication system can be effectively increased.

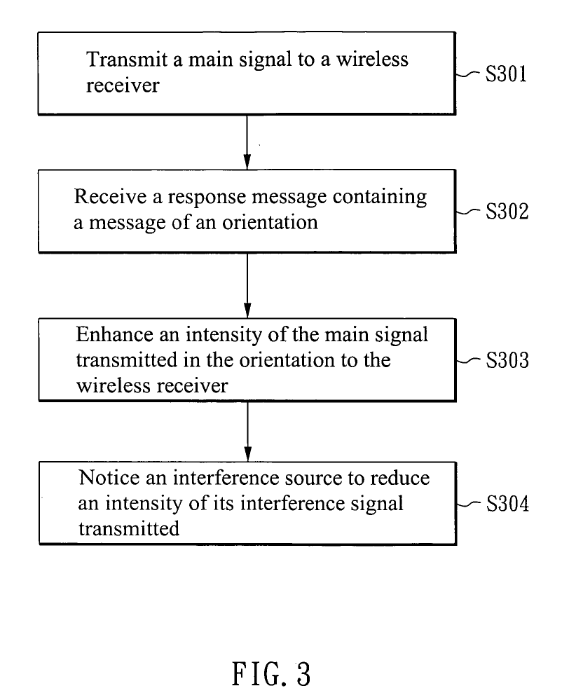

FIG. 3 is a flowchart of a transmitter according to an embodiment of the invention. As shown in FIGS. 1 and 3, the base station 10 transmits the main signal 101 to the mobile phone 20 (S301). The mobile phone 20 receives the main signal 101 and accordingly computes an orientation relative to the base station 10, and further sends a response message containing a message of the orientation to the base station 10 (S302). The base station 10 accordingly enhances the power intensity of the main signal 101 transmitted in the impinging angle to the mobile phone 20 (S303), and notices the interference source (base station 30) to reduce the power intensities of the interference signals 301 and 302 transmitted in the impinging angle to the mobile phone 20 (S304). As such, the signal to noise ratio of the entire communication system can be effectively increased, and the communication quality is also increased.

Although the present invention has been explained in relation to its preferred embodiment, it is to be understood that many other possible modifications and variations can be made without departing from the spirit and scope of the invention as hereinafter claimed.

What is claimed is:

1. A method of suppressing co-channel interference in a wireless communication system, which is used in a wireless receiver, the method comprising:
a co-channel receiving step, which receives a plurality of signals with the same frequency, wherein the signals contain a main signal and one or more interference signals, and the main signal is transmitted by a wireless transmitter with a preamble orthogonal to the preambles of interference signals;
a power intensity computing step, which computes power intensities of the signals respectively based on the preambles;
a power intensity comparing step, which compares the power intensities of the signals; and
a filtering step, which selects a signal with power intensity higher than a threshold as the main signal, and spatially filters out the remaining signals that are regarded as the interference signals from different impinging angles.

2. The method as claimed in claim 1, further comprising:
an orientation computing step, which computes an orientation of the wireless transmitter relative to the wireless receiver; and
a feedback step, which sends a response message containing a message of the orientation to the wireless receiver.

3. The method as claimed in claim 2, further comprising a signal enhancing step, which enhances a power intensity of the main signal transmitted in an impinging angle to the wireless receiver based on the message of the orientation.

4. The method as claimed in claim 3, further comprising an interference source noticing step, which uses the wireless transmitter to send the message of the orientation to an interference source, wherein the interference source transmits an interference signal and reduces a power intensity of the interference signal transmitted in an impinging angle to the wireless receiver based on the message of the orientation.

5. The method as claimed in claim 2, further comprising an interference reducing step, which reduces a power intensity of an interference signal transmitted in an impinging angle to the wireless receiver based on the message of the orientation, when an interference source transmitting the interference signal receives the response message.

6. A method of suppressing co-channel interference in a wireless communication system, which is used in a wireless transmitter, the method comprising the steps:
a main signal transmitting step, which transmits a main signal with an assigned frequency to a wireless receiver, wherein the main signal contains a preamble;
a response receiving step, which receives a response message sent by the wireless receiver, wherein the response message contains a message of an orientation computed by the wireless receiver based on the main signal; and
a signal enhancing step, which enhances an intensity of the main signal transmitted in an impinging angle to the wireless receiver based on the message of the orientation.

7. The method as claimed in claim 6, further comprising an interference source noticing step after the response receiving step, which uses the wireless transmitter to send the message of the orientation to an interference source, wherein the interference source transmits an interference signal and reduces an intensity of the interference signal transmitted in an impinging angle to the wireless receiver based on the message of the orientation.
